(19) United States
(12) Patent Application Publication
(10) Pub. No.: US 2015/0200567 A1
(43) Pub. Date: Jul. 16, 2015

(54) REDUNDANT POWER SUPPLY SYSTEM FOR REDUCING STANDBY POWER CONSUMPTION

(71) Applicant: ZIPPY TECHNOLOGY CORP., New Taipei City (TW)

(72) Inventors: Yung-Hsin HUANG, New Taipei City (TW); Tsung-Chun CHEN, New Taipei City (TW)

(73) Assignee: ZIPPY TECHNOLOGY CORP., New Taipei City (TW)

(21) Appl. No.: 14/152,587

(22) Filed: Jan. 10, 2014

(51) Int. Cl. H02J 9/06

(52) U.S. Cl. CPC H02J 9/061

(57) ABSTRACT

A redundant power supply system for reducing standby power consumption includes a plurality of power supply modules and a power integration backboard. Each power supply module includes a first power supply path, a second power supply path, and an operating power conversion unit disposed on the first power supply path and including a standby power input path. The power integration backboard is connected to the power supply modules and includes an operating power integration unit and a standby power conversion unit. The standby power conversion unit is connected to the standby power input paths of the power supply modules to provide the standby powers to the power supply modules. The standby power conversion unit includes a power adjustment mechanism which determines a corresponding number of the second power supply paths for converting the external powers to the standby powers according to a power consumption signal.

### FIELD OF THE INVENTION

The present invention relates to a redundant power supply system, and particularly to a redundant power supply system that reduces standby power consumption through adjusting an output condition of the standby power.

### BACKGROUND OF THE INVENTION

Advanced Technology Extended (ATX) is one of the most common motherboard specifications. A power supply compliant to the ATX specifications, instead of being directly connected to an activation switch of an information system, is only activated by a trigger of a motherboard. In normal conditions, the power supply constantly provides a standby power (commonly referred to as 5Vsb) that at all times allows the motherboard to readily enter an activated state. When the activation switch is pressed by a user, the motherboard outputs an activation signal to the power supply. The power supply then utilizes the standby power as an activation power for activating the output of operating power required for normal operations of the motherboard. The so-called operating power is, for example, 12V, 5V and 3.3V in the ATX power specifications.

In modern technologies, a redundant power supply system is proposed for meeting power supply stability requirements. In general, a redundant power supply system chiefly includes at least two power supply modules and a power integration backboard connected to the power supply modules. To provide power, the power integration backboard determines the power that each of the power supply modules outputs according to power consumption conditions of a load connected. That is to say, the power that the load consumes is provided in a shared manner by the power supply modules. If one of the power supply modules becomes damaged and malfunctions, the damaged power supply module is disengaged from the power integration backboard, and is replaced by another functional power supply module. However, the power supply modules utilized in the redundant power supply system may be individually regarded as a power supply. In addition to providing the motherboard with the required operating power, the power supply modules also convert and output the standing power. According to different power consumption requirements, the load needs both of the operating power in different amounts and the standby power. For example, the redundant power supply system includes four power supply modules, each of which constantly outputs 1 W of standby power. However, as the load requires only 1 W of the standby power, the remaining 3 W of the standby power is regarded as waste and is consumed by other components. That is to say, a current redundant power supply system is incapable of adjusting the amount of a standby power according to the amount of power that the load consumes, leading to unnecessary power waste.

### SUMMARY OF THE INVENTION

Therefore the primary object of the present invention is to provide a redundant power supply system capable of adjusting an output standby power according to a power consumption condition of a load.

To achieve the above object, a redundant power supply system for reducing standby power consumption is provided. The redundant power supply system includes a plurality of power supply modules and a power integration backboard connected to the power supply modules. Each of the power supply modules is independently connected to an external power source to receive an external power. Each of the power supply modules includes a first power supply path and a second power supply path that are connected to the external, power source, and an operating power conversion unit disposed on the first power supply path and for converting a power level of the external power. The operating power conversion unit includes a standby power input path. The power integration backboard includes an operating power integration unit and a standby power conversion unit. The operating power integration unit is connected to the first power supply paths of the power supply modules, and integrates the operating powers to output an integrated operating power to a load. The standby power conversion is connected to the second power supply paths of the power supply modules, converts the received external powers to a standby power, and outputs the standby power to the load. The standby power conversion unit is further connected to the standby power input paths of the power supply modules to provide the standby power to the power supply modules. Further, the standby power conversion unit includes a power adjustment mechanism. The power adjustment mechanism captures a power consumption signal from the load to accordingly determine the corresponding number of second power supply paths for converting the external power to the standby power.

In one embodiment, each of the operating power conversion unit of the power supply modules includes a rectification filter unit connected to the first power supply path, a power factor correction unit connected to the rectification filter unit, a transformer, a pulse width control unit, a switch element, and a modulation output unit.

In one embodiment, each of the power supply modules includes a switch unit. The switch unit is disposed on the second power supply path, and determines whether to set ON or OFF the second power supply path.

In one embodiment, each of the power supply modules includes a digital control unit for controlling the switch unit.

In one embodiment, each of the power supply modules includes a status indication lamp. The status indication lamp is connected to the switch unit, and generates color variation according to a status of the switch unit.

In one embodiment, the power integration backboard includes a power modulation unit. The power modulation unit is connected to the operating power integration unit, receives the operating power, converts a power level of the operating power, and outputs at least one modulated operating power to the load.

With the above structure, the redundant power supply system of the present invention offers the following features compared to the prior art. With the standby power conversion unit of the present invention, a standby power corresponding to requirements of the load is outputted, thereby preventing power waste caused by a conventional redundant power supply system that is incapable of modulating the standby power.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of a redundant power supply system for reducing standby power consumption according to an embodiment of the present invention;

FIG. 2 is a schematic diagram of a redundant power supply system for reducing standby power consumption according to another embodiment of the present invention; and

FIG. 3 is an appearance diagram of a redundant power supply system for reducing standby power consumption according to an embodiment of the present invention.

### DETAILED DESCRIPTION OF THE PREFERRED EMBODIMENTS

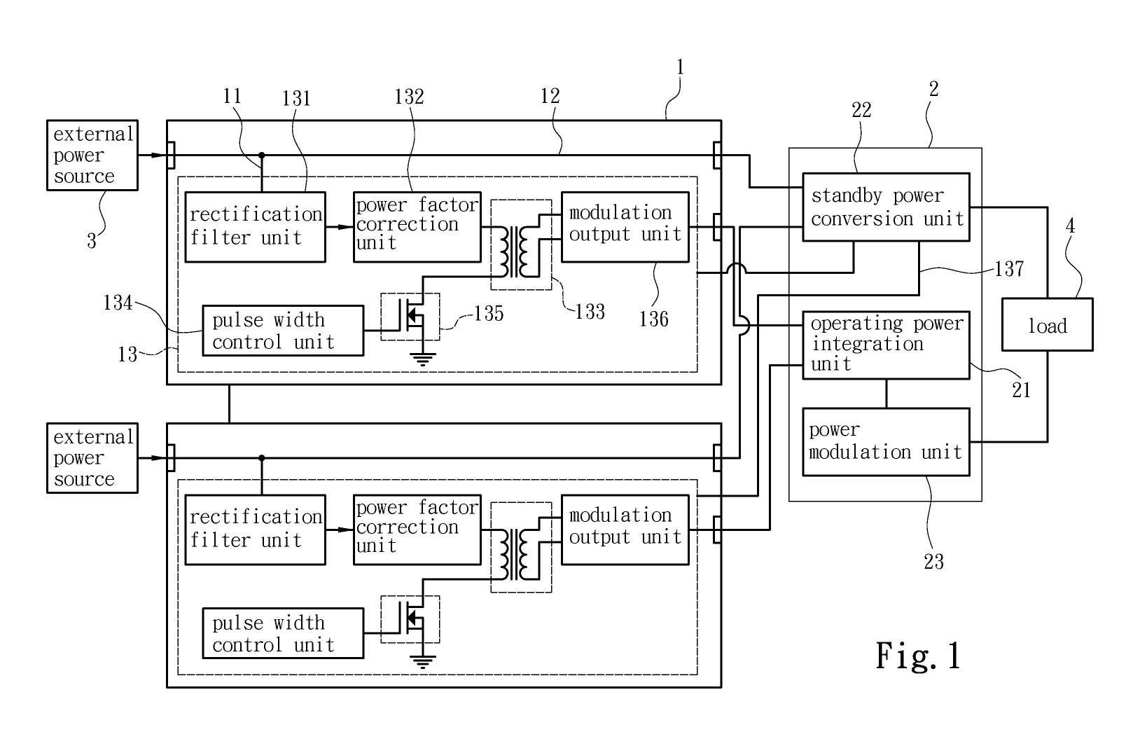

Referring to FIG. 1, a redundant power supply system for reducing standby power consumption according to an embodiment of the present invention mainly includes a plurality of power supply modules 1 and a power integration backboard 2. In the present invention, an example of two power supply modules 1 is given for illustration purposes. In practice, the number of the power supply modules 1 may be determined according to application requirements of the redundant power supply system. Each of the power supply modules 1 is independently connected to an external power source 3 to receive an external power. According to an embodiment of the present invention, the external power source 3 may be a city power source or an industrial power source. Further, each of the power supply modules 1 includes a first power supply path 11 and a second power supply path 12 that are connected to the external power source 3, and an operating power conversion unit 13 disposed on the first power supply path 11. The first power supply path 11 and the second power supply path 12 receive the external power from the external power source 3. The operating power conversion unit 13, disposed on the first power supply path 11, converts a power level of the received external power to output an operating power. For example, the operating power may 12Vdc specified in the ATX motherboard specifications. More specifically, the operating power conversion unit 13 of each of the power supply modules 1 includes a rectification filter unit 131 connected to the first power supply path 11, a power factor correction unit 132 connected to the rectification filter unit 131, a transformer 133, a pulse width control unit 134, a switch element 135 and a modulation output unit 136. The external power is first rectified and filtered by the rectification filter unit 131, and a power factor of the rectified and filtered external power is then adjusted by the power factor correction unit 132 according to a transforming adjustment level. The pulse width control unit 134 outputs a driving signal for determining a duty cycle of the switch element 135. The switch element 135 is periodically turned on or off to modulate a coil current of the transformer 133. The modulation output unit 136 modulates the power outputted by the transformer 133 and outputs the operating power. Further, the operating power conversion unit 13 of the present invention includes a standby power input path 137. The standby power input path 137 of the present invention is primarily for receiving a standby power and utilizing the standby power to activate the operating power conversion unit 13.

The power integration backboard 2, connected to the power supply modules 1, includes an operating power integration unit 21 and a standby power conversion unit 22. The operating power integration unit 21 is connected to the first power supply paths 11 of the power supply modules 1, and receives the operating powers transmitted by the first power supply paths 11 from the first power supply paths 11. The operating power integration unit 21 further integrates the operating powers and outputs an integrated operating power to a load 4. For example, the load 4 may be an information apparatus such as a server or a personal computer. The standby power conversion unit 22, connected to the second power supply paths 12 of the power supply modules 1, receives the external powers transmitted by the second power supply paths 12 from the second power supply paths 12, converts the external powers into the standby power by converting the power level of the external powers, and outputs the standby power to the load 4. The standby power conversion unit 22, further connected to the standby power input paths 137 of the power supply modules 1, outputs the standby power to each of the power supply modules 1. The standby power conversion unit 22 of the present invention further includes a power adjustment mechanism. The power adjustment mechanism captures a power consumption signal from the load 4, and determines the corresponding number of second power supply paths 12 for providing the external powers to the standby power conversion unit 22 for the power level conversion. More details of the power adjustment mechanism are given below. When the load 4 operates and requires 2 W of the standby power, the standby power conversion unit 22 converts the power consumption requirement of the load 4 into the power consumption signal, and determines and converts the required amount of the external power according to the power consumption signal to output the standby power satisfying the requirement of the load 4. That is to say, if the standby power conversion unit 22 obtains the external power from only one of the power supply modules 1 and converts and outputs 1 W of the standby power, the requirement of the load 4 is not satisfied. Thus, according to the power consumption signal, the standby power conversion unit 22 determines the number of the power supply modules 1 (two power supply modules 1 in the embodiment) from which the standby power conversion unit 22 receives the external powers, converts the received external powers to the standby power, and outputs the standby power that satisfies the requirement of the load 4. Conversely, when the load 4 does not require a high standby power, the standby power conversion unit 22 adjusts a power condition according to which each of the power supply modules 1 outputs the external powers, thereby reducing the power consumption of the redundant power supply system under a standby state. Further, the power integration backboard 2 of the present invention further includes a power modulation unit 23. The power modulation unit 23, connected to the operating power integration unit 21, receives the operating power and modulates a power level of the operating power to output at least modulated operating power. For example, the modulated operating power is 5Vdc or 3.3Vdc specified in the ATX motherboard specifications.

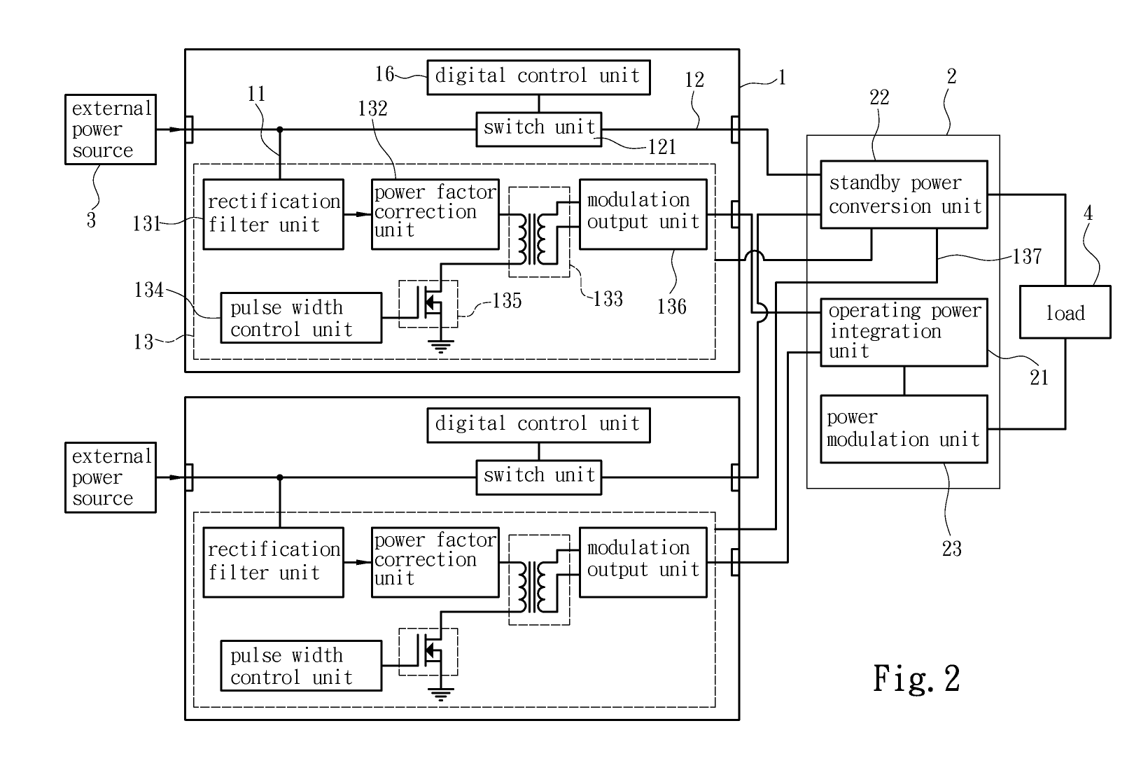

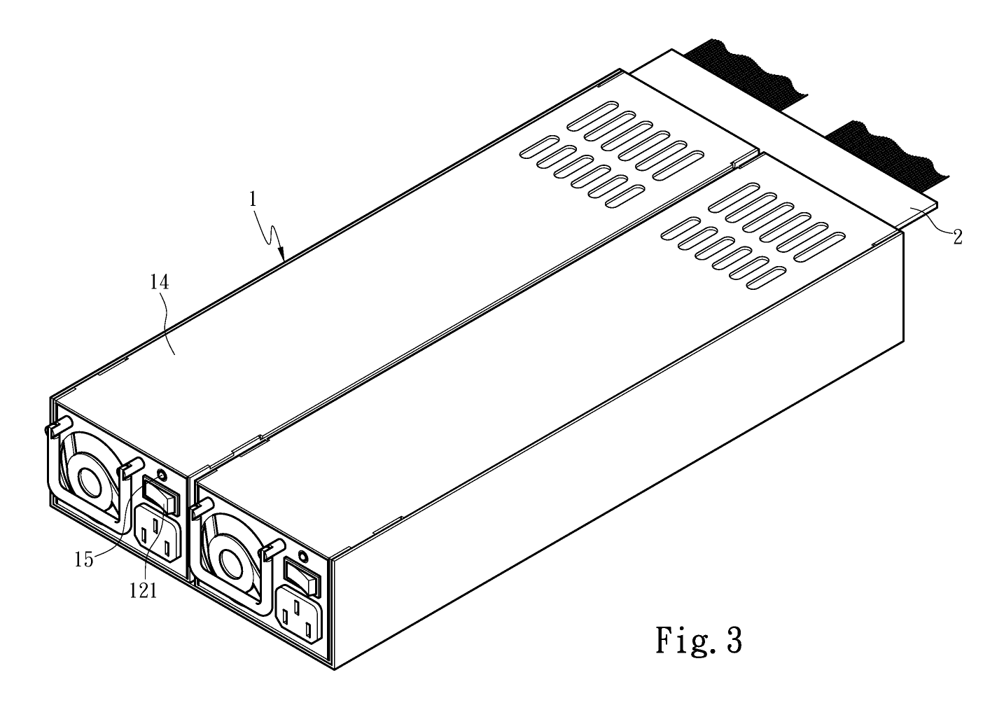

Referring to FIG. 2, in addition to the above structure, according to one embodiment of the present invention, a switch unit 121 is further disposed on the second power supply path 12 of each of the power supply modules 1, and ON or OFF of the second power supply path 12 is determined by setting ON or setting OFF the switch unit 121. Thus, according to requirements, a user may turn on or turn off the switch unit 121 to further terminate the power supply module 1 to supply the external power to the power integration backboard 2. The switch unit 121 may be a physical switch (as shown in FIG. 3) disposed on a housing 14 of each of the power supply modules 1. Further, each of the power supply modules 1 may include a status indication lamp 15. The status indication lamp 15 is connected to the switch unit 121, and generates color variation according to the status of the switch unit 121. Further, each of the power supply modules 1 may include a digital control unit 16 for controlling the switch unit 121. The digital control unit 16 receives a control signal via the power integration backboard 2. The control signal controls ON or OFF of the switch unit 121.

In conclusion, the redundant power supply system for reducing standby power consumption of the present invention includes a plurality of power supply modules and a power integration backboard. Each of the power supply modules includes a first power supply path, a second power supply path, and an operating power conversion unit disposed on the first power supply path and, including a standby power input path. The power integration backboard, connected to the power supply modules, includes an operating power integration unit and a standby power conversion unit. The standby power conversion unit, further connected to the standby power input paths of the power supply modules, provides the standby power to the power supply modules. Further, the standby power conversion unit includes a power adjustment mechanism which determines the corresponding number of the second power supply paths for converting the external powers to the standby powers according to a power consumption signal.

What is claimed is:

1. A redundant power supply system for reducing standby power consumption, comprising:
a plurality of power supply modules, each of the power supply modules being independently connected to an external power source to receive an external power, each of the power supply modules comprising:
a first power supply path and a second power supply path, connected to the external power source; and
an operating power conversion unit, disposed on the first power supply path for converting a power level of the external power to output an operating power, comprising a standby power input path;
a power integration backboard, connected to the power supply modules, comprising:
an operating power integration unit, connected to the first power supply paths of the power supply modules for integrating the received operating powers and outputting an integrated operating power to a load; and
a standby power conversion unit, connected to the second power supply paths of the power supply modules for converting the received external powers to a standby power and outputting the standby power to the load;
wherein, the standby power conversion unit is further connected to the standby power input paths of the power supply modules to provide the standby powers to the power supply modules, and comprises a power adjustment mechanism that captures a power consumption signal from the load to determine a corresponding number of the second power supply paths to be set ON for converting the external powers to the standby powers.

2. The redundant power supply system for reducing standby power consumption of claim 1, wherein the operating power conversion unit of each of the power supply modules comprises a rectification filter unit connected to the first power supply path, a power factor correction unit connected to the rectification filter unit, a transformer, a pulse width control unit, a switch element and a modulation output unit.

3. The redundant power supply system for reducing standby power consumption of claim 1, wherein each of the power supply modules comprises a switch unit disposed on the second power supply path for determining ON or OFF of the second power supply path.

4. The redundant power supply system for reducing standby power consumption of claim 3, wherein each of the power supply modules comprises a digital control unit for controlling the switch unit.

5. The redundant power supply system for reducing standby power consumption of claim 3, wherein each of the power supply modules comprises a status indication lamp connected to the switch unit for generating color variation according to a status of the switch unit.

6. The redundant power supply system for reducing standby power consumption of claim 1, wherein the power integration backboard further comprises a power modulation unit connected to the operating power integration unit for receiving the operating power and converting a power level of the operating power to output at least one modulated operating power to the load.
